(19) United States
(12) Patent Application Publication
(10) Pub. No.: US 2014/0291258 A1
(43) Pub. Date: Oct. 2, 2014

(54) METHOD AND DEVICE FOR ENRICHING A LIQUID WITH OXYGEN

(71) Applicant: Uwe Wuerdig, Berlin (DE)

(72) Inventor: Uwe Wuerdig, Berlin (DE)

(21) Appl. No.: 14/114,263

(22) PCT Filed: Apr. 27, 2012
(86) PCT No.: PCT/DE12/00120

§ 371 Date: Oct. 28, 2013

(30) Foreign Application Priority Data
Apr. 28, 2011 (DE) 10 2011 017 739.6

(51) Int. Cl. C02F 1/74

(52) U.S. Cl. CPC C02F 1/74
USPC 210/750; 210/188

(57) ABSTRACT

The invention relates to a solution for enriching a liquid with oxygen. For this purpose, oxygen from the ambient air is introduced into the liquid by means of an injector and is partially dissolved in it. The liquid which leaves the injector, and which is laden with dissolved and undissolved gas components of the air, is then introduced into at least one degassing unit (2), which is connected downstream to the injector, for the removal of undissolved gas components that form bubbles in the liquid. According to the invention, the injector involves a multiple injector having at least two injector chambers (11, 12, 13, 14). In the degassing unit (2), undissolved oxygen is first separated from the liquid through an intense vortexing of the liquid, and then is once again introduced into the liquid in an injector chamber (13, 14), by aspirating it out as part of a gas-liquid mixture via a return line (18, 18′) of a multiple injector (1), this line connecting the at least one degassing unit (2) to an intake port (6′, 6″) of the related injector chamber (13, 14). The undissolved, difficultly soluble gas components of the air, i.e., undissolved nitrogen in particular, are discharged via a gas discharge valve of the degassing unit (2).

The invention relates to a solution for optimal and controlled enrichment of a liquid with oxygen, in particular air oxygen. It preferably relates to the enrichment of water with oxygen. The subjects of the invention are thus a corresponding method and device designed for implementing the method.

For different application objectives, it is necessary to enrich liquids with a gas or a mixture of gases, by introducing the gas in a controlled manner into the respective liquid and dissolving it in the liquid. For example, it is usual to enrich water, in particular ground water, with oxygen for the purpose of removing iron. Therefore, in the past, a multiple number of solutions have already been proposed for introducing gas into liquids.

It is known, for example, to introduce gas into water by means of a so-called water jet pump, such as is described in CH 85932 A or in DE 1 022 471 B for example, the water jet pump described in the last-named publication serving for the enrichment of the water with air oxygen.

Further, it is known to introduce gas by means of injectors into a liquid in which the liquid flows through a tube-shaped flow channel having a segment constricted in its cross section, utilizing the Venturi principle. A connection or tube segment extending crosswise to the flow channel opens into the constricted segment, an underpressure arising in this connection by means of the liquid flowing past at a high dynamic pressure due to the constriction. By means of the suction effect associated therewith, the gas is aspirated into the flow channel, entrained by the liquid, and a major part of it is dissolved in the liquid. A corresponding injector is described, for example, in U.S. Pat. No. 4,123,800 A.

In fact, such injectors are very effective, so that they make possible a high-grade enrichment of the liquid with the respective gas; however, a complete dissolution of the gas in the liquid cannot be achieved, so that a part of the gas introduced in the region of the injector is entrained by the liquid in undissolved form, particularly with the formation of relatively large bubbles. This is not wanted, however, insofar as pressure surges may arise in the downstream equipment as a result of this, such as in the equipment of a water supply network. Such pressure surges, for example, lead to cavitations in pumps, as a consequence of which, the pumps can be damaged or in fact, even destroyed. Therefore, measures are preferably taken in order to again separate from the liquid the gas or gas mixture that has been introduced into a liquid for purposes of enrichment, but has not been dissolved. So-called degassers or degassing equipment serve(s) for this purpose. Thus, for example, known from EP 07 71 230 B1 is a device, in which a liquid is enriched with gas in an injector and the gas that does not dissolve in the liquid is again separated from the liquid by means of a degasser or liquid-gas separator placed downstream of the injector. The gas separated in this way is ejected into the atmosphere. In the solution described in the publication, pure oxygen or ozone from a corresponding gas supply is injected into the injector for enriching the liquid. According to the publication it is possible with the described system to transfer 85% of the supplied oxygen into the liquid, as long as pure oxygen is used.

A method and a system or a device for dissolving gas in a liquid are known from EP 1 423 182 B1, whereby the liquid enriched with the corresponding gas is discharged into a tank, for example, into a container for fish farming. The gas to be dissolved in the liquid in this case is supplied via an injector to a mixer, in which the liquid that is to be enriched with the gas is also introduced. In a separator connected downstream to the mixer, undissolved gas is separated from the liquid, and the gas is once again introduced into the liquid via the above-named injector. The liquid containing gas dissolved therein passing through the separator is discharged into the named tank. The device is preferably designed for introducing pure gases, such as oxygen, for example.

In fact, it is stated in the publication that gas mixtures, such as air, could also be dissolved in a liquid, such as water, for example, but the device in connection therewith cannot be used in all cases for the discharge of the liquid enriched with gas or gas mixture into the mentioned tank, or rather it cannot be used in individual cases as part of pressurized systems for liquid transport. The reason for this is that there is no actual gas separation process in the separator, but certainly in any case, there is no separation of undissolved, difficultly soluble gaseous components, such as, e.g., nitrogen contained in air, from the gas-liquid mixture containing dissolved and undissolved gases. Rather, in the case of a primary introduction of air or ambient air, both undissolved oxygen components as well as undissolved—since it is difficultly soluble—nitrogen present in air in an essentially higher concentration than oxygen are returned via the injector from the separator back to the mixer. Now, as long as there is at the same time another primary introduction of air into the mixer, the consequence is that continually larger quantities of gases accumulate in a dome above the liquid level in the downstream separator. Following this, in turn, repeated flow separations are to be expected relative to the liquid guided through the device, whereby a gas pillow or gas plug, as it were, might form in the connecting line to the tank receiving the water enriched with oxygen. The liquid is then gradually displaced by this gas plug from this line into the tank, until the plug finally reaches the tank and then is unloaded or collapses, as it were, and liquid enriched with dissolved gas may flow back again temporarily into the connection line from the separator into the tank. As a result, the consequence is pressure fluctuations of the liquid enriched with gas discharged from the separator into the subsequent equipment or equipment parts, which make basically impossible a use of the device described in the publication in pressurized systems, at least in the case of a primary introduction of gas mixtures containing gas fractions of gases having very different dissolving capacities, such as, e.g., inside the pressurized water supply network having a primary input of air.

The object of the invention is to provide a solution that enables an even more effective enrichment of a liquid with oxygen, particularly with oxygen from the ambient air while achieving a very high saturation of the liquid with oxygen. In particular, the solution will make it possible in a particularly advantageous way to enrich liquids inside pressurized systems, such as, for example, the pressurized water supply network, obtaining a particularly high saturation with air oxygen. A method and a device are indicated for this purpose.

The object is achieved by a method with the features of the principal claim. A device suitable for carrying out the method and achieving the object is characterized by the subsequent independent claim. Advantageous embodiments and enhancements of the invention are given by the dependent claims.

According to the method proposed for achieving the object, the oxygen to be enriched in a liquid is introduced into the liquid as part of a gas mixture, i.e., the ambient air, by means of at least one injector, and dissolved in it. The liquid laden with dissolved and undissolved gas components of the air is introduced into a degassing unit connected downstream, relative to the direction of flow of the liquid, for the removal of undissolved gas components forming bubbles.

According to the invention, a multiple injector having at least two injector chambers disposed parallel to one another in the flow direction of the liquid, each having an intake port and brought together in the region of a liquid outlet of the multiple injector is used as the injector, an underpressure being brought about at the intake ports of the chambers by the liquid flowing through the multiple injector. Due to the named underpressure, the ambient air to be introduced into the liquid is aspirated into the multiple injector via the intake port of at least one of the injector chambers of the multiple injector. The undissolved gas components of the air are separated from the liquid in the degassing unit connected downstream to the multiple injector, and the fractions of undissolved oxygen separated from the liquid are introduced as a component of a gas-liquid mixture once again into a multiple injector, which not necessarily, but preferably involves the same multiple injector by means of which the ambient air was originally introduced into the liquid. The gas-liquid mixture is again introduced into the liquid to be enriched with the oxygen in the related multiple injector. According to the invention, in this case, the gas-liquid mixture containing the undissolved oxygen is aspirated out from the degassing unit into the related multiple injector, due to the underpressure caused by the liquid flowing through this multiple injector, in a return line connecting the degassing unit with the named multiple injector.

According to the invention, the supply of oxygen present for enriching the liquid is accordingly particularly efficiently utilized each time by attempting to finally dissolve the fractions not yet dissolved in the liquid which are supplied repeatedly, as it were. In this way, it is possible to transfer into the liquid very high percentages of the oxygen specific for the enrichment of the liquid. It is assured here by the at least one degassing unit that undissolved gas components are again removed from the liquid, so that for example, they do not lead to pressure fluctuations in a water supply network connected downstream to a device operating according to the method of the invention, or, in fact, do not lead to damage of any equipment of this water supply network. In addition, the degassing unit, however, also serves for the purpose of providing these gas fractions in the form of a gas-liquid mixture, i.e., liquid permeated with gas bubbles, for repeated introduction into the liquid. Here, tests have shown that the method according to the invention, for example, makes possible a particularly effective enrichment of water with oxygen from the air, as a result of which, the respective saturation limit for the possible oxygen input of up to approximately 98% is achieved, which is dependent on the pressure and temperature conditions prevailing in the liquid.

Other than the undissolved oxygen, in contrast, the lighter, still undissolved gas components that were separated from the liquid in the degassing unit, composed of the ambient air of up to approximately 78% nitrogen and up to approximately 21% oxygen, which collect in an upper region of the degassing unit due to their lighter weight, such as nitrogen in particular, are discharged into the atmosphere via a gas discharge valve of the degassing unit. With respect to the enrichment of water with oxygen, for example, through the introduction of air, it is of advantage here that nitrogen has an essentially smaller tendency to go into solution in water than does oxygen. The gas fraction that is called residual air here, which is discharged from the degassing unit via the gas discharge valve, preferably a special automatic venting valve, still has a considerably higher nitrogen fraction than “normal” ambient air, since large parts of the air oxygen have previously gone into solution in the multiple injector and on the path of the water to the degassing unit. Of course, however, fractions of previously undissolved oxygen also unavoidably reach the atmosphere with the mentioned residual air via the gas discharge valve, but to a relatively small extent, and this will be disregarded in the following discussion in order to simplify the presentations and corresponding formulations. Likewise, small quantities of nitrogen are also contained in the returned gas-liquid mixture, which basically involves liquid containing air bubbles; although these will also not be considered, it is to be viewed as a deciding factor that undissolved fractions of the oxygen in the liquid, preferably water, as it were, are supplied repeatedly for dissolution. In any case, however, what is essential to the invention is that large parts of the initially still undissolved oxygen for enrichment of the liquid, i.e., water, are repeatedly introduced with the gas-liquid mixture into the multiple injector or into a multiple injector, whereas undissolved fractions of difficultly soluble gases, i.e., nitrogen in particular, are separated from the liquid or from the gas-liquid mixture and are discharged from the system.

A particularly good and effective separation of the undissolved gas fractions from the liquid is achieved according to the invention in that the liquid laden with these as well as with dissolved gas components is intensely vortexed in the degassing unit designed correspondingly for this purpose. The largely bubble-free liquid, which is highly enriched with oxygen due to the effective separation of undissolved gas components, is discharged from the degassing unit via the liquid outlet thereof. Based on this effective separation of undissolved gas components, in which there results an extensive separation of the oxygen, which readily goes into solution, from the gas components, which go into solution only with difficulty in the liquid, such as the undissolved nitrogen fractions, the method of the invention is excellently suitable for application in closed total systems containing a pressurized liquid. In this case, the advantage results simultaneously that with elevated pressure, the saturation limit increases for the oxygen dissolving in the liquid, i.e., the theoretically maximum amount of oxygen that can be dissolved in the liquid and thus also the amount of oxygen actually dissolving in the liquid increase with the application of the method.

A device that achieves the object and that is suitable for conducting the method for enriching a liquid with oxygen from the ambient air is essentially composed of at least one injector, in which the oxygen is introduced into the liquid and is dissolved in the liquid, and of at least one degassing unit connected downstream to the at least one injector, relative to the direction of flow of the liquid. The named injector and the named degassing unit are connected to one another by means of at least one connection line, by means of which the liquid laden with dissolved and undissolved gas components is introduced into the degassing unit. The gas components that have not gone into solution in the liquid are again separated from the liquid in the degassing unit. Each injector and each degassing unit of the device has at least one liquid inlet and one liquid outlet, each liquid inlet of a degassing unit being connected to the liquid outlet of an injector via the already mentioned connection line. Further, each injector has at least one intake port and each degassing unit has at least one liquid outlet for the liquid enriched with the dissolved oxygen.

According to the invention, the at least one injector is designed as a multiple injector having at least two injector chambers disposed parallel to one another in the flow direction of the liquid, these chambers being brought together in the region of its liquid outlet, and each possessing an intake port. Further, in the case of the device proposed for achieving the object, the at least one degassing unit has at least one exhaust connection, which is connected to the intake port of a multiple injector via a return line. Oxygen for enriching the liquid, which is still contained in the gas components that have been separated from the liquid by means of the degassing unit is introduced via the named return line to the respective multiple injector, which is connected to the degassing unit via the return line, as a component of a gas-liquid mixture for repeated introduction into the liquid. In this case, the gas-liquid mixture containing the undissolved oxygen is aspirated out from the degassing unit via an underpressure in the return line, which is caused by the liquid flowing through the multiple injector. The gas components that are lighter than oxygen and that are not dissolved in the liquid, i.e., undissolved nitrogen in particular, in contrast escape via a gas discharge valve disposed in the upper region of the degassing unit, in which these lighter gas components collect. This valve preferably involves a special automatic venting valve. For a particularly effective separation of undissolved gas components from the liquid via the vortexing of the liquid entering into the at least one degassing unit, this vortexing being provided according to the method, the liquid inlet of the degassing unit is designed as a connection opening up tangentially into the degassing unit.

The above-described equipment is intended for an application in closed, pressurized systems, i.e., in particular for application in the pressurized water supply network, based on its special design for implementing the method according to the invention. In respect to the last-named case of application, it makes possible a high-grade enrichment with air oxygen of the pressurized water inside the network, whereby advantageously, it does not require the introduction of pure oxygen from special oxygen supplies.

Insofar as it is discussed above and in the patent claims, when the device according to the invention is presented, although there is at least one multiple injector and at least one degassing unit, it will be clear that, of course, depending on the particular application, very different configurations of the equipment with several multiple injectors and/or several degassing units, as the case may be, are conceivable, wherein, however, corresponding to the basic principle of the solution according to the invention, a type of back-coupling, so to speak, exists between each degassing unit and at least one multiple injector, so that a gas or a gas mixture for enriching the liquid and which has still not gone into solution and is thus separated from the liquid again in the degassing unit, is once more introduced into a multiple injector for the purpose of repeated introduction into the liquid in the form of a gas-liquid mixture. In the following, for simplicity in the description of other possible embodiments of the device, generally one multiple injector and one degassing unit will be discussed. However, the invention will in no way be limited by this to a device having only one multiple injector and one degassing unit.

In an advantageous enhancement of the device according to the invention, the liquid outlet for the liquid enriched with oxygen is also designed as a connection disposed tangentially with respect to the degassing unit or tangentially opening into it. The targeted intense vortexing of the liquid in the degassing unit is promoted in this way.

Corresponding to a preferred embodiment of the device according to the invention, a pump is also disposed in the connection line between the multiple injector and the degassing unit, by means of which the liquid laden with dissolved and undissolved gas or gas mixture is introduced into the degassing unit connected downstream to the multiple injector. The liquid introduced into the degassing unit for the separation of the undissolved gas components is pressurized by means of this pump. On the one hand, pressure losses that occur in the liquid when it is discharged from the multiple injector and which are not desired, for example, in the case when the device according to the invention is integrated into the water supply network, are compensated by this. On the other hand, the vortexing of the liquid achieved thereby in the degassing unit is additionally reinforced in a particularly advantageous manner. Through the increase in pressure effected by means of the pump, in this case in connection with the tangential design or arrangement of the liquid inlet as well as optionally of the liquid outlet, it is achieved that a very intense vortexing occurs in the liquid entering into the degassing unit, through which, under effects of detachment from the walls due to the high energies operating in the center of the vortex, according to the centrifugal principle, the undissolved gas components are separated as a component of a gas-liquid mixture from the liquid containing the dissolved gas components.

The one or more multiple injectors or the individual injector chambers thereof operate preferably in the known way according to the Venturi principle, according to which the ambient air or the “residual air” returned from the degassing unit is aspirated in via an intake port and is introduced into the liquid, the intake port being disposed in the region of a cross-sectional constriction given for the liquid flowing through the respective injector chamber. In this case, via this intake port, due to the suction effect of the liquid flowing past, the ambient air or the “residual air” is drawn into the multiple injector or, respectively, into the corresponding injector chamber thereof, and thus into the liquid, so to speak.

Preferably, but not absolutely necessary, at least one injector chamber of the multiple injector is connected via its intake port to an exhaust connection of a degassing unit, which is connected to the same multiple injector, also via a connection line for the liquid laden with the gas or the gas mixture exiting from it.

In a practical embodiment of the device, a non-return valve and a suction-protection guard are disposed in the intake port for aspirating in the ambient air. The named suction-protection guard thus prevents the entrainment of contaminants into the multiple injector via the intake port, these contaminants possibly being aspirated in together with the ambient air due to the suction effect. The non-return valve prevents an undesired discharge of liquid from the multiple injector via the intake port thereof for the ambient air, especially in the case of a pressure-loaded shutdown of the equipment.

Corresponding to a particularly preferred embodiment, the degassing unit is designed as a tube-shaped container. The container is widened in its diameter in an upper segment and is narrowed underneath the liquid inlet that is connected to the liquid outlet of a multiple injector. Through this shaping, an intense vortexing of the liquid entering into the degassing unit, and thus the separation of the undissolved gas components exiting as bubbles in appearance, is particularly promoted. An exhaust connection connected to an intake port of a multiple injector and the gas discharge valve are disposed in the head region of the container. In addition, in this embodiment, another exhaust connection connected to an intake port of a multiple injector, optionally, of the same multiple injector, is disposed in the foot region of the container. The exhaust connection in the head region of the container in this case is configured such that, proceeding from this exhaust connection, a tube segment extending below the liquid inlet of the degassing unit projects into the container. It is assured in this way that rising lighter gas is discharged to the outside via the discharge valve, but undissolved gas bubbles of oxygen that are present in the liquid are introduced as a component of a gas-liquid mixture directly into the exhaust connection via the named tube segment and are transferred from here into the injector chamber connected to it. Preferably, for the purpose of directly aspirating out the gas-liquid mixture containing undissolved oxygen from the foot region of the degassing unit, proceeding from the exhaust connection disposed in this region, a tube segment extending above the liquid outlet for the liquid enriched with oxygen projects out into the container forming the degassing unit.

An example of embodiment of the invention will be explained below with the help of drawings. In the appended drawings:

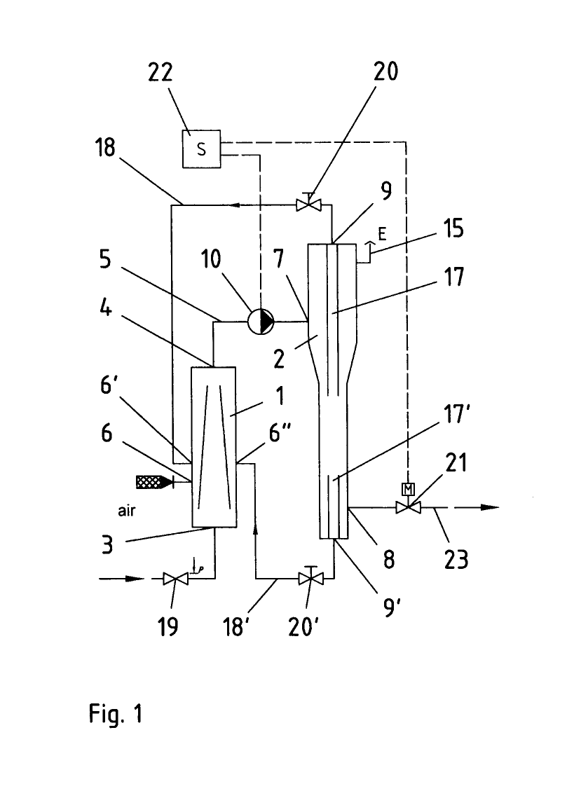

FIG. 1: shows the schematic diagram of a possible embodiment of the device according to the invention;

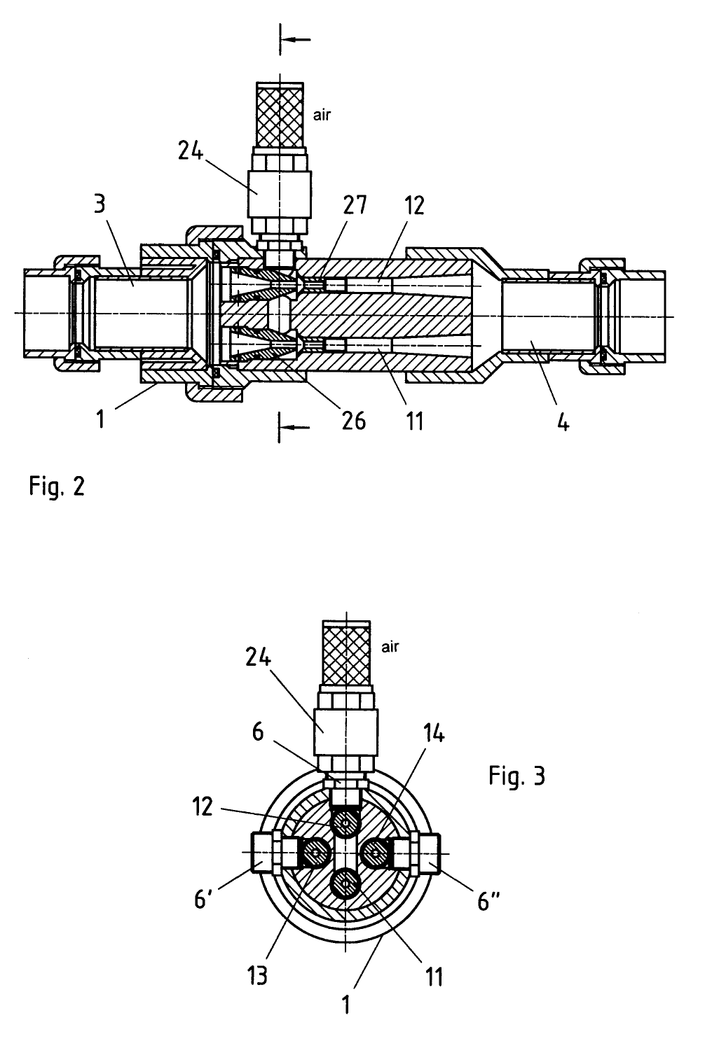

FIGS. 2 and 3: show a possible embodiment of the multiple injector of the device;

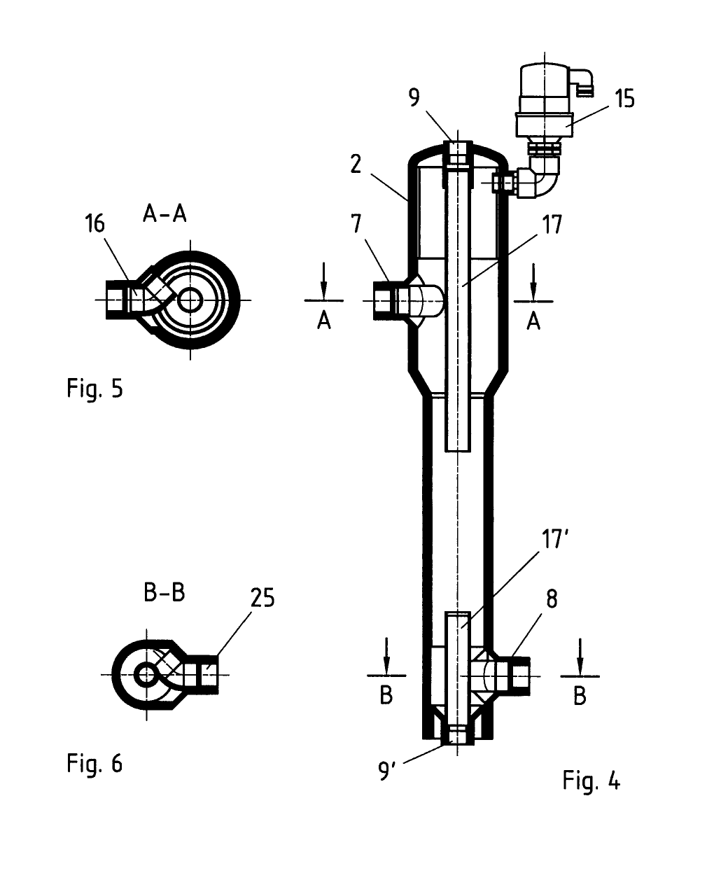

FIGS. 4 to 6: show a possible embodiment for a degassing unit of the device.

FIG. 1 shows a schematic diagram of a possible embodiment of the device according to the invention. The embodiment shown in the example involves a device for the enrichment of water with air oxygen. This device is essentially composed of a multiple injector 1 and a degassing unit 2; connection lines 5, 18, 18′, 23 for the water to be enriched with oxygen and for the gas-liquid mixture, which is present as water containing bubbles of undissolved oxygen or undissolved air; valves 19, 20, 20′, 21 of a pump 10 disposed in the connection lines 5, 18, 18′, 23; and a control device 22 controlling the pump 10 and the valves 19, 20, 20′, 21.

The device shown serving for the enrichment of water with oxygen is, for example, part of a water supply system, in which, for example, drinking water obtained from a fountain is enriched with oxygen for the purpose of removing iron. The corresponding water is introduced into the multiple injector 1 having the system pressure of the water supply system. In the embodiment shown in FIG. 1, a pressure-reducing valve 19, which is not mandatory, is connected upstream to the multiple injector 1, this valve somewhat reducing the pressure as needed, and it can particularly keep the pressure nearly constant. The multiple injector 1 involves an injector, the injector chambers 11, 12, 13, 14 of which operate according to the Venturi principle. The water flowing into the injector chambers 11, 12, 13, 14 is introduced through a region of a liquid channel that is constricted in its cross section. An intake port 6 for aspirating in ambient air is provided in this constricted region for two injector chambers 11, 12. By increasing the flow velocity that the water is subject to in the constricted region, a suction effect arises at intake port 6, by means of which, air is drawn in from the environment into the multiple injector 1 and is introduced into the water, the oxygen of the air for the most part being dissolved in the water. The water laden with the gas mixture, i.e., partially dissolved oxygen and undissolved air, is introduced into the degassing unit 2 via the connection line 5. A pump 10, by means of which the water is pressurized prior to input into the degassing unit 2 and which is controlled by the control device 22, is disposed in the connection line 5. The undissolved components of the air are again separated from the water according to the centrifugal principle in degassing unit 2. The water containing the oxygen dissolved therein is brought via a liquid outlet 8 and the connection line 23 of the degassing unit to equipment connected downstream, which is not shown here, of the water supply system or the water supply network. The components of the air not dissolved in the multiple injector 1 are separated from the water containing the gas components dissolved therein in the degassing unit 2 of the device according to the invention as a component of a gas-liquid mixture or a gas-water mixture having bubbles. The nitrogen and excess air or residual air collecting in the upper part of the degassing unit 2 are discharged to the atmosphere via a gas discharge valve 15. In contrast, essential portions of the undissolved oxygen are aspirated out again in the way essential to the invention as a component of a gas-water mixture via exhaust connections 9, 9′ and return lines 18, 18′ for the purpose of a repeated and targeted input into the water in the multiple injector 1. Additional intake ports 6′, 6″ are provided for this at the multiple injector in a constricted region of each of the injector chambers 13, 14, and, by means of these ports, the gas-water mixture containing undissolved oxygen separated from the water containing the dissolved gas in the degassing unit 2 in the head region and in the foot region of the degassing unit 2 is aspirated out to the multiple injector 1.

FIGS. 2 and 3 show the multiple injector 1 belonging to the device according to FIG. 1 in two sectional views, i.e., once in axial section (FIG. 2) and once in radial section (FIG. 3). Four injector chambers 11, 12, 13, 14 are disposed parallel to one another in the multiple injector 1 according to the example shown relative to the flow direction of the water that is to be enriched, which is guided through the multiple injector 1. Each time, two injector chambers 11, 12 of the injector chambers 11, 12, 13, 14 operating according to the Venturi principle serve for the enrichment of the water with oxygen by the input of ambient air. A common intake port 6 is disposed at the multiple injector 1 for these two injector chambers 11, 12, and by means of this port, air from the atmosphere is aspirated in due to the suction effect of the water flowing through the injector chambers 11, 12. The strong suction effect in these injector chambers 11, 12, but also in injector chambers 13, 14, is produced by the water moving at high flow velocity through the multiple injector 1 or through injector chambers 11, 12, 13, 14 thereof. In this case, a correspondingly high flow velocity of the water through nozzles disposed in each of the the injector chambers 11, 12, 13, 14, i.e., a jet nozzle 26 and a reducing nozzle 27 for cross-sectional reduction, which is connected downstream to the jet nozzle in the flow direction. A non-return valve (not shown in detail) and a suction-protection guard 24 for protecting against contaminants are disposed in the intake port 6. The air aspirated in is dissolved in the water, largely in microfine form, in the injector chambers 11, 12. The water laden with dissolved and undissolved air is then discharged via the liquid outlet 4 of the multiple injector 1 and introduced into the degassing unit 2 via the connection line 5 shown in FIG. 1. The other two injector chambers 13, 14 of the multiple injector 1 each have an intake port 6′, 6″, as can be recognized in the radial section view of FIG. 3. The fractions of air oxygen, which are still not dissolved in the water and which have previously been separated from the water containing the gas components dissolved therein in the degassing unit 2, as a component of a gas-water mixture appearing in the form of water containing a large number of bubbles, are once more introduced into the water via these intake ports 6′, 6″. They are aspirated out from the degassing unit 2 via the exhaust connections 9, 9′ thereof by the suction effect produced by the water flowing through these injector chambers 13, 14, and are again introduced into the water in the injector chambers 13, 14. The flow channels formed by the four injector chambers 11, 12, 13, 14 disposed parallel to one another at the liquid outlet 4 of the multiple injector 1 are brought together again prior to the discharge of the liquid from the multiple injector 1.

FIGS. 4 to 6 show the degassing unit 2 of the device according to FIG. 1, also in several sectional representations, i.e., in an axial section (FIG. 4) and further, once in a radial section through the head region (FIG. 5) of the degassing unit 2, and once in a radial section through the foot region (FIG. 6) of the degassing unit 2. As can be recognized from the view of FIG. 5 relating to the radial section through the head region, the water laden with dissolved oxygen and undissolved air is introduced into the degassing unit 2 via a connection 16, which opens up tangentially into the tube-shaped container of the degassing unit 2. The water enriched with dissolved oxygen exits the degassing unit 2 via the liquid outlet 8 also designed in the form of a tangential connection 25. The water flowing into the degassing unit 2 is intensely vortexed in the container of the degassing unit 2 in this way as well as by the pressure additionally produced previously by means of the pump 10 (see FIG. 1). Due to the vortexing, the undissolved components of the air are separated as a gas-water mixture from the water containing dissolved oxygen. The undissolved nitrogen or more precisely stated, the undissolved air, which has been separated from the water and which has a higher nitrogen fraction when compared with the ambient air due to the fact that a part of the oxygen of the air originally introduced into the water has gone into solution in the water, is discharged into the atmosphere via the gas discharge valve 15. The still undissolved oxygen, in contrast, is aspirated out to the multiple injector 1 for the most part as a component of a gas-water or gas-air mixture via the exhaust connections 9, 9′ in the head region and in the foot region of the degassing unit 2. As can be seen, for this purpose, a tube segment 17 extending from the exhaust connection 9 disposed in the head region to below the inlet connection 16 for the water, and a tube segment 17′ extending from the exhaust connection 9′ disposed in the foot region below the liquid outlet 8 to above the liquid outlet 8 project into the container of the degassing unit 2. The gas-water mixture containing the undissolved oxygen and which has been separated by the centrifugal effect, is aspirated out via the tube segment 17 directly from the water enriched with dissolved oxygen in the direction of the upper exhaust connection 9 and from here via the intake port 6′ into the injector chamber 13. Correspondingly, the gas-water mixture containing undissolved oxygen is aspirated out directly into the injector chamber 14 via the tube segment 17′, the lower exhaust connection 9′ as well as the intake port 6″. The water enriched with dissolved oxygen, which has been vortexed in the degassing unit 2 or its container for the separation of the undissolved gas components, as has already been mentioned, is finally discharged via the liquid outlet 8 at the foot of the container and introduced into the downstream equipment of the water supply system.

### LIST OF REFERENCE NUMBERS

1 Multiple injector

2 Degassing unit

3 Liquid inlet

4 Liquid outlet

5 Connection line

6, 6′, 6″ Intake port

7 Liquid inlet

8 Liquid outlet

9, 9′ Exhaust connection

10 Pump

11, 12, 13, 14 Injector chamber

15 Gas discharge valve

16 Connection

17, 17′ Tube segment

18, 18′ Return line

19 Pressure-reducing valve

20, 20′, 21 Valve

22 Control device

23 Connection line

24 Suction-protection guard

25 Connection

26 Jet nozzle

27 Reducing nozzle

1. A method for enriching a liquid with oxygen, whereby the oxygen is introduced into the liquid as part of a gas mixture, i.e., the ambient air, by means of an injector and is partially dissolved in it, and whereby the liquid which leaves the injector and which is laden with dissolved and undissolved gas components of the air is introduced into a degassing unit connected downstream to the injector for the removal of undissolved gas components forming bubbles in the liquid, is hereby characterized in that a multiple injector having at least two injector chambers disposed in parallel to one another in the flow direction of the liquid, each having an intake port and brought together in the region of a liquid outlet of the multiple injector is used as the injector; an underpressure is brought about at the intake ports of the chambers by the liquid flowing through the multiple injector, this underpressure aspirating in the ambient air via an intake port; and in that the undissolved components of the air are separated from the liquid introduced into the degassing unit coming from the multiple injector by vortexing the liquid in the degassing unit designed correspondingly for this purpose, whereby still undissolved oxygen is aspirated out of the degassing unit into the multiple injector as a component of a gas-liquid mixture via an exhaust connection of the degassing unit and a return line connecting this unit with the intake ports of a multiple injector due to the underpressure at the intake ports, and is once again introduced into the liquid flowing through the multiple injector; whereas, lighter (when compared to oxygen), undissolved gas components of the air, i.e., essentially nitrogen, collecting in the upper part of the degassing unit are discharged into the atmosphere via a gas discharge valve of the degassing unit, and the liquid enriched with dissolved oxygen exits from a liquid outlet of the degassing unit.

2. A device for enriching a liquid with oxygen, having at least one injector, in which the oxygen is introduced into the liquid as part of a gas mixture, i.e., the ambient air, and is dissolved in the liquid, and having at least one degassing unit connected downstream to the at least one injector relative to the direction of flow of the liquid, wherein each injector has at least one liquid inlet, a liquid outlet, and an intake port, and wherein each degassing unit has at least one liquid inlet, which is connected via a connection line to a liquid outlet of an injector, and at least one liquid outlet for the discharge of the liquid containing the oxygen dissolved therein, is hereby characterized in that the one or more injectors is (are) designed as a multiple injector having at least two injector chambers, which are disposed in parallel to one another in the direction of flow of the liquid and are brought together in the region of its liquid outlet, and each having an intake port, and in that least one intake port is disposed for aspirating in the ambient air, and at least one intake port is connected via a return line to an exhaust connection of the degassing unit or to one of the degassing units, by means of which, still undissolved oxygen contained in the liquid is aspirated out of the related degassing unit into the multiple injector as a component of a gas-liquid mixture, wherein the liquid inlet of the at least one degassing unit is designed as a connection opening tangentially into this unit, and the at least one degassing unit has a gas discharge valve in its upper region, for discharging undissolved gas components of the air that are collecting there and that are lighter than oxygen, i.e., essentially nitrogen.

3. The device according to claim 2, further characterized in that the liquid outlet of the at least one degassing unit is designed as a connection opening up tangentially into the degassing unit.

4. The device according to claim 2, further characterized in that a pump is disposed in the connection line between the at least one multiple injector and the at least one degassing unit, by means of which the liquid laden with dissolved and undissolved gas or gas mixture is introduced into the degassing unit connected downstream to the multiple injector, so that the liquid introduced into the degassing unit is additionally pressure-loaded for the separation of the undissolved gas components.

5. The device according to claim 2, further characterized in that at least one injector chamber of the multiple injector is connected via its intake port to an exhaust connection of a degassing unit, which is connected to the related multiple injector also via a connection line for the liquid laden with dissolved and undissolved gas components of the air.

6. The device according to claim 2, further characterized in that at least one injector chamber of the multiple injector has an intake port for aspirating in ambient air, in which a non-return valve and a suction-prevention guard are disposed therein.

7. The device according to claim 2, further characterized in that the at least one degassing unit is designed as a tube-shaped container, its diameter being widened in an upper segment, with an exhaust connection connected to an intake port of a multiple injector as well as the gas discharge valve being disposed in the head region thereof, and with another exhaust connection connected to an intake port of a multiple injector being disposed in the foot region thereof, whereby, proceeding from the exhaust connection disposed in the head region, a tube segment extending below the liquid inlet projects into the container of the degassing unit.

8. The device according to claim 7, further characterized in that proceeding from the exhaust connection disposed in the foot region, a tube segment extending above the liquid outlet projects into the container of the degassing unit.
